(19) United States
(12) Patent Application Publication
(10) Pub. No.: US 2005/0241950 A1
(43) Pub. Date: Nov. 3, 2005

(54) Method for forming a coating on a wheel and the structure of the coating

(76) Inventor: Kuo-Bin Chen, Taoyuan County (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/838,732

(22) Filed: May 3, 2004

(51) Int. Cl. B05D 5/12

(52) U.S. Cl. 205/118; 205/183

(57) ABSTRACT

A method for forming a coating on a wheel and the structure of the coating includes at least one indicating zone set on a sidewall of the wheel and at least one recess mark defined in the wheel. Ann electroplated layer is formed on the wheel except the recess mark, a color layer is formed on the recess mark and a guarding layer is formed on the color layer. A mass of powder is spread on a wheel and then a color layer with desired color is spread on the wheel body. A guarding layer is formed by spreading the enamel made of majority of Resin on the color layer. The guarding layer and the color layer in the indicating zone are removed by surface turning, and an electroplated layer is formed by electroplating the wheel after the surface turning process.

### FIELD OF THE INVENTION

The present invention relates to a method for forming a coating, and more particularly to a method for forming a coating on a wheel and the structure of the coating.

### DESCRIPTION OF RELATED ART

With reference to FIG. 9, a conventional wheel comprises a wheel body (50) that includes an outward sidewall (51) having a rim (52) formed on the wheel body (50). A coating slice (53) is previously surface treated and rolled on the rim (51) in order to cover the rim (51) and perform a vivid appearance of the conventional wheel so that the cost of the conventional wheel will be higher.

However, the coating slice (53) cannot be fully corresponded to the rim (51) and a gap (531) will be formed between the coating slice (53) and the rim (51). Therefore, the wheel body (50) can easily get dirt when the dirt got stuck in the gap (531) after being used for a period of time, and finally the dirt covers the rim (51) so that the vivid appearance of the conventional wheel will be disappeared.

Furthermore, the coating slice (53) will be gradually peeled off from the rim (51) due to the vibration caused by using of the conventional wheel because the coating slice (53) cannot be fully tightly corresponded to the rim (51). The peeling-off situation may cause some parts of the coating slice (53) raised from the rim (51). On one hand this situation may get people injured when under repairing, and on the other this situation will make the appearance of the conventional wheel looks messy.

The weight of the combination of the wheel body (50) and the coating slice (53) will be increased so that the waste of the fuel will be produced when a driving car has the conventional wheel with the coating slice (53) equipped.

The coating slice (53) is easily to be formed a difference of thickness when being rolled on the rim (51), which will make the center of the gravity of the conventional wheel turn aside, so that the conventional wheel will be easily vibrated due to the reason of the deviate of the center of the gravity when operating and accelerate the damage of the wheel body (50).

The present invention provides a method for forming a coating on a wheel to mitigate or obviate the disadvantages of the conventional wheel.

### SUMMARY OF THE INVENTION

The main objective of the present invention is to provide a method for forming a coating on a wheel and the structure of the coating.

To achieve this objective, the method and the structure in accordance with the present invention comprises a wheel body and a sidewall is formed thereon, at least one indicating zone is set on the sidewall and at least one recess mark is defined therein.

Below are four surface treatments to make a coating on the wheel body.
1. Surface powder painting process: a mass of powder is spread on a wheel body and a color layer with desired color is formed on the wheel body due to the mass of powder after being heated.
2. Surface enameling process: a guarding layer is formed on the color layer by spreading the enamel of resin on the color layer.
3. Surface turning process: the guarding layer and the color layer in the recess mark are removed by surface turning.
4. Surface electroplating process: an electroplated layer is formed by electroplating the wheel body after the surface turning process.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention and the detailed description of the preferred embodiment in addition to the scope of the invention defined by the claims taken in conjunction with the accompanying drawings.

### BRIEF DESCRIPTION OF THE DRAWINGS

FIG. 1 is a flow chart of a method for forming a coating on a wheel in accordance with the present invention;

FIG. 2 is a perspective view of wheel before being surface treated;

FIG. 3 is a cross-sectional view of the wheel in FIG. 2 along line 3-3;

FIG. 4 is a cross-sectional view of the wheel in FIG. 3, wherein a color layer is formed on the periphery of the wheel;

FIG. 5 is a cross-sectional view of the wheel in FIG. 4, wherein a guarding layer is formed on the color layer;

FIG. 6 is a cross-sectional view of the wheel in FIG. 5, wherein the color layer and the guarding layer are partially worn out;

FIG. 7 is a cross-sectional view of the wheel in FIG. 6, wherein a electroplated layer is formed where the color layer and the guarding layer are worn out;

FIG. 8 is a perspective view of a wheel that has a coating formed by the method in accordance with the present invention; and

FIG. 9 is a perspective view of conventional wheel in partially cross section in accordance with the prior art.

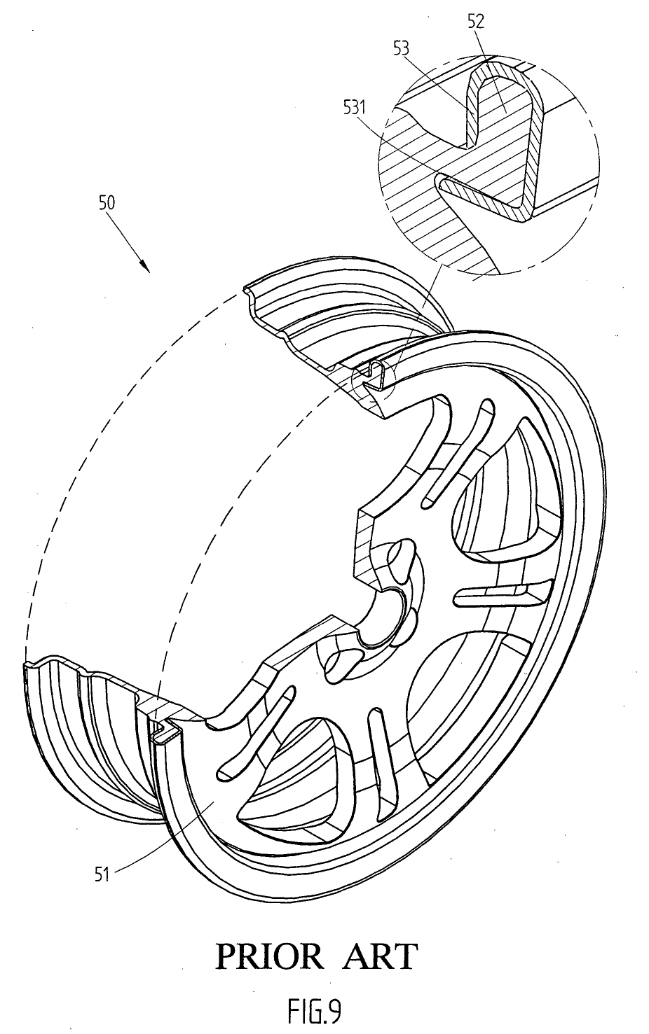

### DETAILED DESCRIPTION OF THE PREFERRED EMBODIMENT

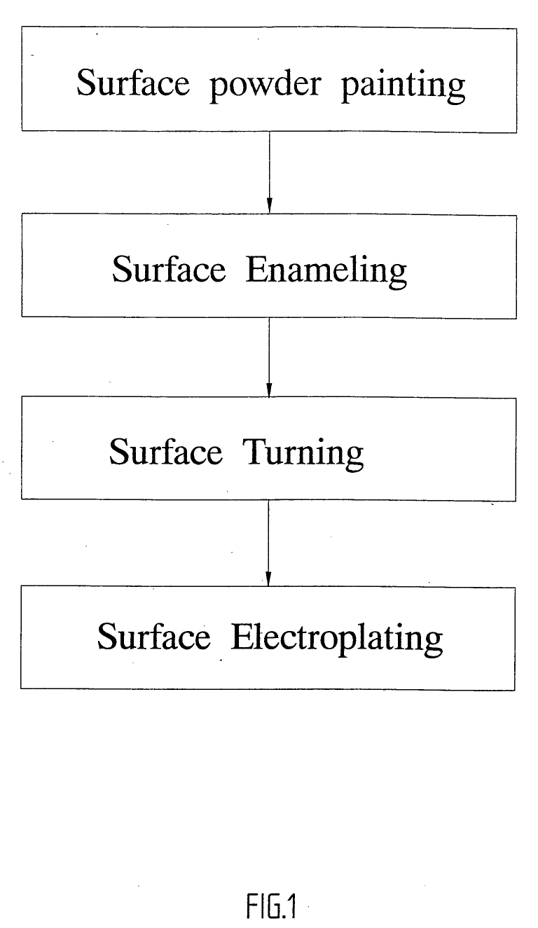

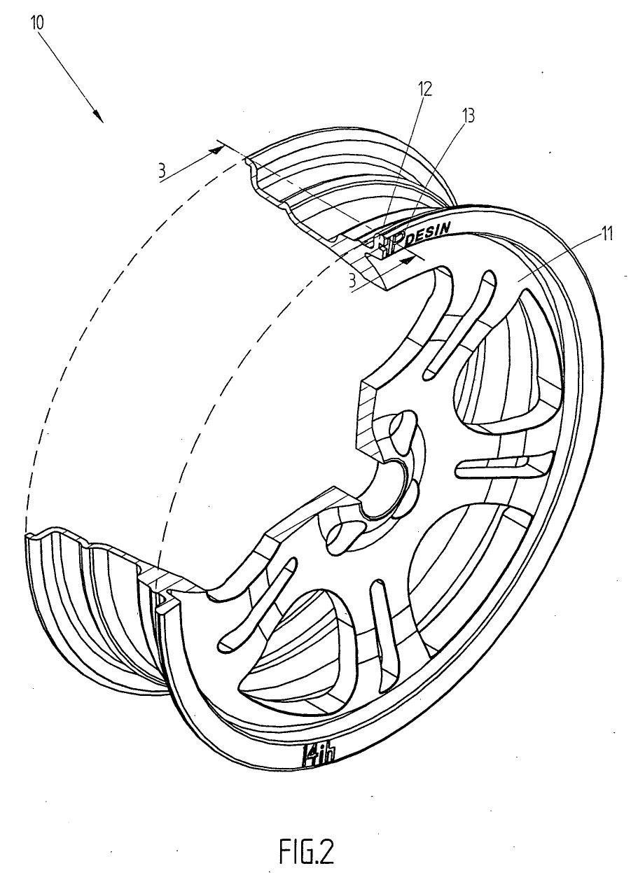

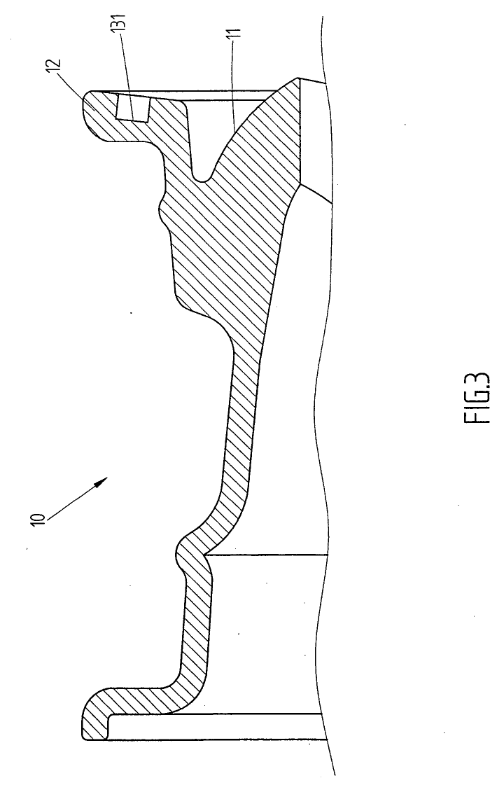

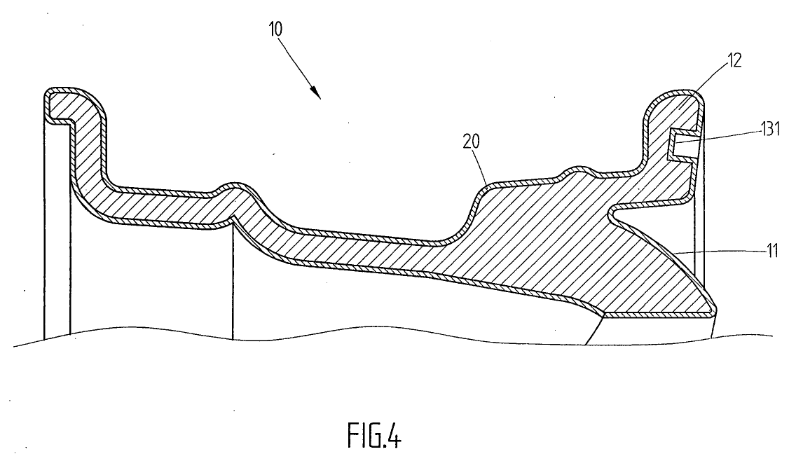

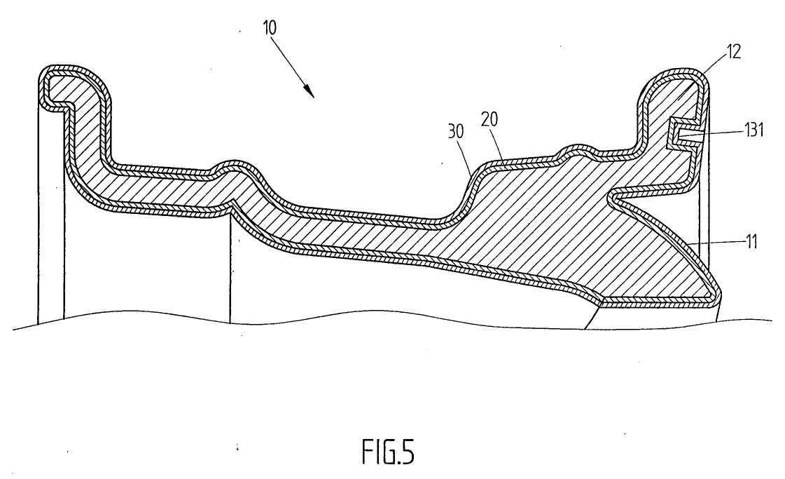

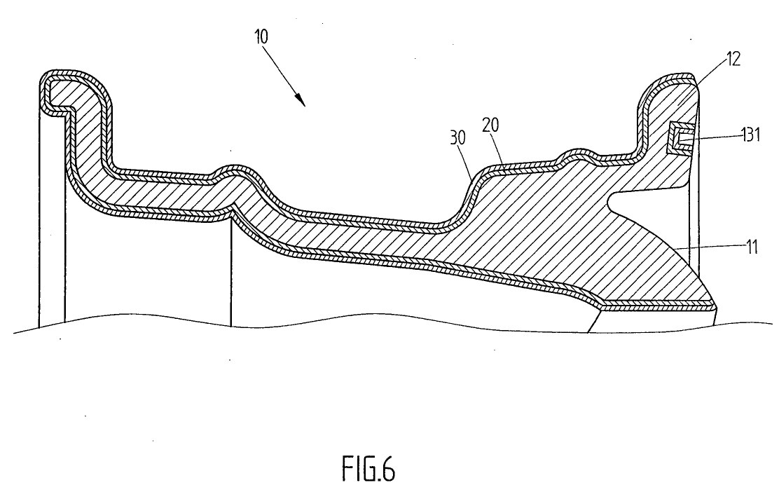

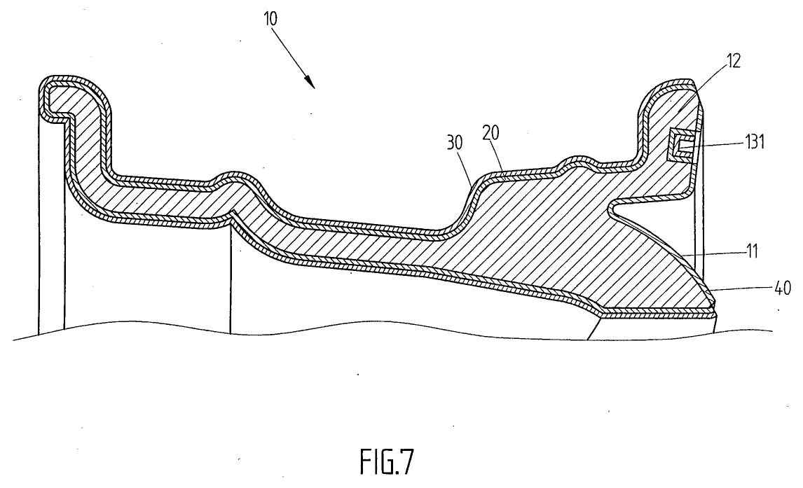

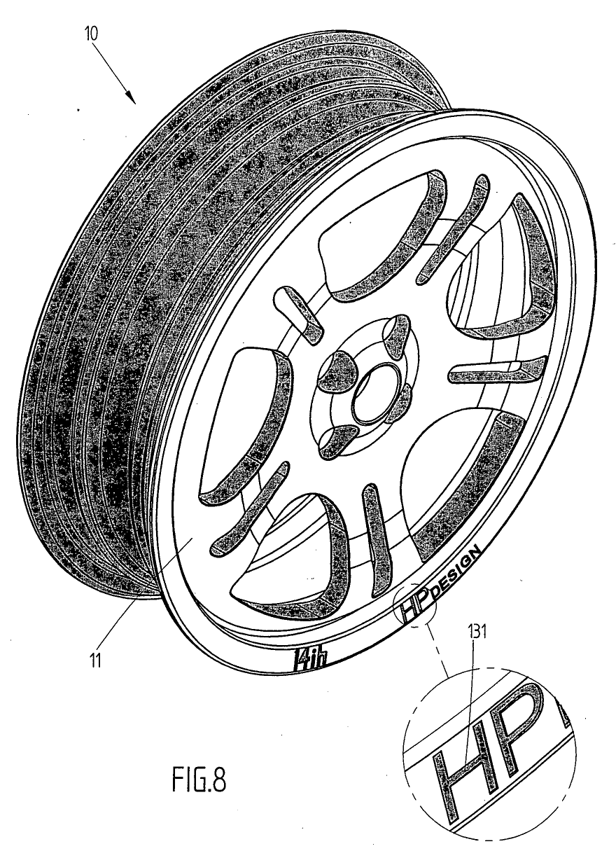

As shown in FIGS. 1 to 8, a method for forming a coating on a wheel in accordance with the present invention comprises the following steps.

Step 1 is a surface powder painting process. In this process, a wheel body (10) is previously processed to make an outer periphery of the wheel body (10) clean and dry, and a mass of powder is spread on the wheel body (10) and baked. The outer periphery of the wheel body (10) is painted to form a color layer (20) after being baked to make the wheel body (10) perform a desired color.

Step 2 is a surface enameling process. In this process, the baked wheel body (10) is coated with enamel to form a guarding layer (30) in order to protect the wheel body (10) from being scrubbed and corroded. The composition of the enamel contains 76% of Resin, 23% of Additive and 1% of Flowagont. The resin includes Acrylic Resin Polymer for being a main reagent and Amino Resin Polymer for being a cross linker.

Below is the chemical formula for the Acrylic Resin Polymer, the percentage of the composition is generally form 50% to 80%. In the preferred embodiment of the present invention, the percentage of the Acrylic Resin Polymer is 53%.

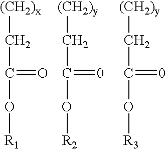

Below is the chemical formula for the Amino Resin Polymer, the percentage of the composition is generally 20% to 40%. In the preferred embodiment of the present invention, the percentage of the composition of the Amino Resin Polymer is 23%. The purpose for the cross linker is to make the powder, the color layer (20) and the guarding layer (30) attach one another easily:

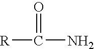

The flowagont contains 0.1% to 0.8% of Paraffin wax for being used as a leveling and wetting agent and the formula for the Paraffin wax is CH₃(CH₂)₁₄C—O(CH₂)₂₄CH₃ or 0.1% to 0.8% of Silicon for being used as a Leveling and wetting agent and a Defoamer, the formula for the Silicon is SiR₂O.

The Additive contains 10% BaSO₄ which has a function to erase the holes formed on the surface of the guarding layer (30) and increases the thickness of the guarding layer (30), and 12% SiO₂ to make the guarding layer (30) have anti-acid and anti-alkali qualities.

Step 3 is a surface turning process. In this process, the color layer (20) and the guarding layer (30) are partially removed to form an indicating zone (12) so that the recess mark (121) in the indicating zone (12) still keeps the color layer (20) and the guarding layer (30).

The last process, step 4, is a surface electroplating process. In this process, the wheel body 10 will be surface-electroplated to form an electroplated layer (40), but the recess mark (121) will not be electroplated due to the insulation of the guarding layer (30) so that there will be a visional difference between the color layer (20) and the electroplated layer (40) on the appearance of the wheel body (10). This process can also be instead of plating with chromium.

Here are the advantages of the present invention:
1. The electroplated layer (40) itself has a mirror-like quality, so that there is no need to add any coating slice to perform the good-looking appearance.
2. No waste of the fuel will be produced when a driving car equips the wheel body (10) due to the reduction of weight of the car by removing the coating slice. No one will get hurt due to the raise of the coating slice when repairing the wheel body (10). The center of the gravity will not turn aside due to the remove of the coating slice.
3. The indicating zone (12) can be anywhere on the wheel body (10) or the rim, and the combination express of the color layer (20) and the electroplated layer (40) can be various to perform the combinative appearance of the wheel.
4. The word of the size, type or design on the wheel body (10) can be clearly seen due to the color layer (20) and the guarding layer (30) are attached thereon and distinguished from the electroplated layer (40).

The present invention includes that contained in the appended claims, as well as that of the foregoing description. Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

1. A method for forming a coating on a wheel comprising the steps of:
previously processing a wheel body;
surface powder painting process: a mass of powder spread on the wheel body, then a color layer with desired color spread on the wheel body;
surface enameling process: a guarding layer formed by spreading the enamel made of majority of resin on the color layer;
surface turning process: the guarding layer and the color layer in the indicating zone removed by surface turning; and
surface electroplating process: an electroplated layer formed by electroplating the wheel body after the surface turning process.

2. The method as claimed in claim 1, wherein the composition of the enamel is 76% of Resin, 23% of Additive and 1% of Flowagont, the resin includes Acrylic Resin Polymer for being a main reagent and Amino Resin Polymer for being a cross linker, below the chemical formula for the Acrylic Resin Polymer, the percentage of the composition being generally 50% to 80% and the best being 53%: 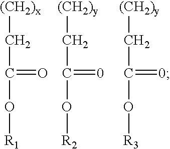
below being the chemical formula for the Amino Resin Polymer, the percentage of the composition being generally 20% to 40% and the best is 23%, the purpose for the cross linker making the powder, color layer and the guarding layer attach one another easily: 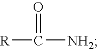
the Flowagont containing 0.1% to 0.8% of Paraffin wax for being used as a Leveling and wetting agent and the formula for the Paraffin wax being CH₃(CH₂)₁₄C—O(CH₂)₂₄CH₃ and 0.1% to 0.8% of Silicon for being used as a Leveling and wetting agent and a Defoamer, the formula for the Silicon is SiR₂O; and
the Additive containing 10% BaSO₄ which has a function to erase the holes formed on the surface of the guarding layer and increase the thickness of the guarding layer, and 12% SiO₂ to make the guarding layer have anti-acid and anti-alkali qualities.

3. A structure of the coating on a wheel comprising at least one indicating zone formed on a sidewall of the wheel and at least one recess mark defined in the sidewall of the wheel, an electroplated layer formed an outer periphery of the wheel except the recess mark, a color layer formed on the outer periphery of the wheel and a guarding layer formed on the color layer.
